(19) United States
(12) Patent Application Publication
(10) Pub. No.: US 2010/0199771 A1
(43) Pub. Date: Aug. 12, 2010

(54) ULTRASONIC SCANNING APPARATUS WITH A TUNING FORK-TYPE VIBRATOR

(76) Inventors: Richard S. KOPLIN, New York, NY (US); Martin Gersten, Irvington, NY (US); Allison Hopper, Irvington, NY (US); Susannah Gersten, Brooklyn, NY (US); Allen Gersten, Berkeley, CA (US)

Correspondence Address: GOTTLIEB RACKMAN & REISMAN PC, 270 MADISON AVENUE, 8TH FLOOR, NEW YORK, NY, 10016-0601, US

(21) Appl. No.: 12/643,186

(22) Filed: Dec. 21, 2009

Related U.S. Application Data
(60) Provisional application No. 61/149,057, filed on Feb. 2, 2009.

(51) Int. Cl. G01N 29/265

(52) U.S. Cl. 73/634

(57) ABSTRACT

This invention relates to ultrasonic scanning apparatus wherein an ultrasonic probe is mounted on a resonant assembly for continuous reciprocating motion. The resonant member has natural frequency of resonance. Preferably, the resonant assembly is disposed in a hand-held probe.

### RELATED APPLICATIONS

This application claims priority to U.S. Provisional Application Ser. No. 61/147,057 filed Feb. 2, 2009, incorporated herein by reference.

The subject matter of this application is related to the subject matter of application Ser. No. 12/046,681 filed Mar. 12, 2008 and Ser. No. 12/117,039 filed May 8, 2008, both incorporated by reference in their entirety.

### BACKGROUND OF THE INVENTION

A. Field of Invention

This invention pertains to an ultrasonic scanning apparatus in which a mechanically resonating or vibrating member resembling a tuning fork supports an probe generating ultrasonic sound waves and detecting the resulting waves reflected from a target. The apparatus is particularly applicable for medical scanners used for imaging organs such as the eye of a patient.

B. Background of the Invention

Ultrasonic imaging refers to an apparatus that makes use of an ultrasonic probe which repeatedly emits pulses of high-frequency sound at a target as the probe is pivoted about an axis. The apparatus further includes a receiver that receives the resulting echo signals from the target. The received echo signals are electronically synchronized to the movement of the probes and processed and resulting signals are converted into a visual image or some other representation indicating various characteristics of the subject tissues. The apparatus is particularly useful for generating images of human organs and tissues and is used extensively for imaging a patient's eye.

Several techniques have been used for generating a sweeping sound for scanning the target, however, by and large these techniques use one of two main approaches that are in common use: a mechanical and an electronic approach. The mechanical approach includes a probe that generates a single ultrasonic beam. The probe is mounted on the end of an arm or similar mechanical member. The arm is supported by a hinge at the opposite end and is pivoted around the hinge in a reciprocating angular motion thereby causing the ultrasonic beam from the probe to sweep across and scan the target. This approach has several problems related to the fact that it is difficult to track or predict the movement/position of the probe accurately. Hence the resulting image may have some inherent errors.

The electronic approach uses a probe formed of a plurality of ultrasonic transducers arranged in an array. The electronic approach generally provides greater speed, precision and repeatability of sound beam motion than the mechanical approach. However, the array approach is inherently more expensive than the mechanical approach. In other words the electronic probe array provides greater accuracy but at a higher price.

### SUMMARY OF THE INVENTION

As discussed above, in a typical ultrasonic scanner using the mechanical approach, the probe is mounted on a pivoting arm. An illustrative arrangement is illustrated in the above-identified application Ser. No. 12/046,681 filed Mar. 12, 2008 and Ser. No. 12/117,039 filed May 8, 2008, wherein the pivoting arm is reciprocated actively through a preselected arc. In the present invention, instead of pivoting arm, a cantilevered plate is used as a means of providing a reciprocating motion for the probe. The plate is made of a high quality steel or other similar material that has well known inherent resilient characteristics that provide it with a natural resonant mode similar to a tuning fork. The plate is fixed at one end while the probe is preferably mounted on the opposite end. Because of its resiliency, the plate has a natural frequency of resonance and therefore once it is displaced and released, the bar resonances angularly at its natural frequency for a long time even if it is not excited. In the present invention, an excitation device is provided to insure that the bar resonates at sufficient amplitude for the purposes of the subject device. The natural frequency of vibration of the plate is determined by the dimensions of the plate, the materials used to make the plate. Moreover, any other foreign elements mounted on the bar will affect its natural resonant frequency as well.

A tuning fork is formed of two opposed arms that resonate in opposite directions. This structure is replicated in the present invention by providing a counterbalancing arm constructed and arranged so that the arm and the plate form a resonant assembly with the tips or ends of the bar and the plate resonating simultaneously in opposite directions. While typically the arms of a tuning fork have identical dimensions (or, more properly, they are identical mirror images of each other), in the present invention, the bar and the plate need not be identical as long as their resonant characteristics are matching. In a preferred embodiment, the plate is formed with an elongated cutout or window and the counterbalancing bar is disposed in the window and affixed near the base of the plate.

### BRIEF DESCRIPTION OF THE DRAWINGS

FIG. 1 shows a somewhat schematic elevational view of a resonator assembly for an ultrasonic scanner device constructed in accordance with this invention;

FIG. 2 shows a block diagram of an electric control circuit used to activate the resonant bar of the device of FIG. 1;

FIG. 3 shows a block diagram of an alternate embodiment of the control circuit. And

FIG. 4 shows an elevational view of an ultrasonic scanner device incorporating the resonator assembly.

### DETAILED DESCRIPTION OF THE INVENTION

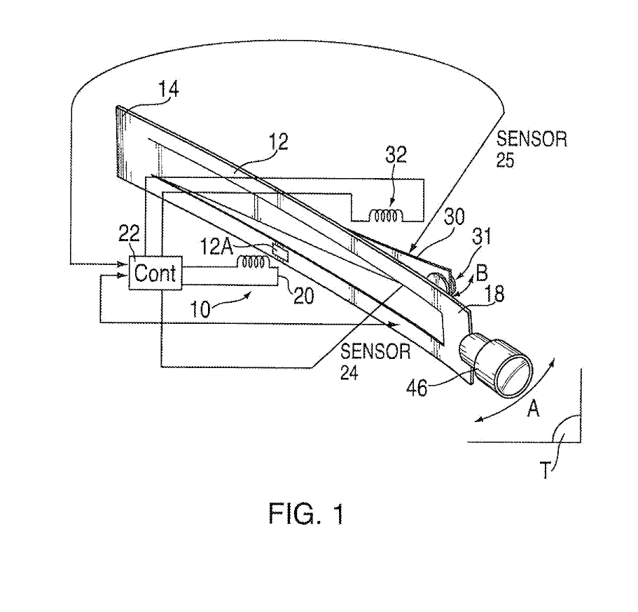

As mentioned above, the present invention provides an ultrasonic device in which the mechanical vibrator uses a tuning-fork type resonating assembly. A preferred embodiment of the invention is shown in FIG. 1. The device is preferably incorporated into a hand-held apparatus or housing for imaging the eye of a person. The housing itself has been omitted from FIG. 1 for the sake of simplicity but is described in conjunction with FIG. 4. Preferably, the probe is arranged to move transversally along an arc of about ±5 mm with respect to a longitudinal axis of the housing. The probe includes an ultrasonic transducer that sends ultrasonic sound waves into the eye and detects the corresponding echoes therefrom. The novelty of the invention resides in the mechanism for reciprocating the probe.

As shown in FIG. 1, an ultrasonic device 10 constructed in accordance with this invention consists of a cantilevered plate 12 fixed to the housing at one end 14. The plate 12 is flexible and resilient and carries a probe 16 at the opposite end 18. More specifically, the plate 14 is made from a material and has dimensions such that when excited, it vibrates angularly with respect to end 14 by an amplitude sufficient to move the probe 16 along an arc of angle A. Arc A and the natural resonance frequency F of the plate are selected so that they meet the requirements for scanning a target T with the probe 16.

The plate 12 can be excited using various means. In one embodiment, an electromagnetic coil 20 is mounted adjacent to the plate 12 and the plate is either made of a ferromagnetic material or is provided with a ferromagnetic element 12A adjacent the coil 20. An electronic control circuit 22 provides excitation signals to the electromagnetic coil 20 that cause the plate 12 to vibrate at its resonant frequency F and predetermined amplitude A thereby reciprocating the probe 16 as discussed. Although it is possible to vibrate the plate 12 at various frequency, exciting the plate 12 to vibrate at its natural frequency F is very advantageous because it can be performed using only a small amount of energy. Moreover, the motion of the plate 12 and probe 16 are well known and therefore the position of the probe 16 can be tracked very easily. As previously discussed, it is important that the position of the probe 16 during the scanning of target T is important so that the readings obtained by the probe can be properly correlated with respective characteristics of the target T.

Therefore, if necessary, a sensor 24 may also be positioned adjacent to the plate 12 to determine the position of end 18 very carefully and to transmit this position to the control circuit 22. For example, the sensor 24 may be a Hall effect sensor used to sense a magnet 24A on the plate 12.

The device 10 may be implemented only with a plate 14 as the vibrating member. However, it may be advantageous to provide a counterbalancing bar for the device to counteract the vibration of plate 12. Therefore, in one embodiment, the plate 12 is formed with an opening or cutout 13 by making a U-shaped cut to form a secondary element or beam 30. The beam 30 can be formed so that when the plate is at rest, the beam 30 and plate 12 are co-planar. Alternatively, the beam 30 is bent so that it is disposed at a predetermined angle with respect to the plate 12.

The beam 30 acts as a counterbalancing bar to plate 12 and is attached to the plate 12 near end 14 as shown. The beam 30 and the plate 12 cooperate to define a vibrating system similar to a tuning fork with the ends of the beam 30 and plate 12 resonating in opposite directions simultaneously. Since the plate 12 and beam 30 have different shapes and sizes, the beam 30 is preferably shaped, sized and, if necessary, provided with additional weights to insure that it has the same mechanical and dynamic characteristics as plate 12 and therefore the two elements cooperate just like the two legs or tines of a tuning fork, with the plate 12 vibrating with its tip describing an arc A while the bar 30 describes an arc B with its tip. The resonant frequency of the resulting assembly, F, is in the same range as the frequency used in standard devices to reciprocate the probe. Typically, this frequency is in the range of 12-15 HZ.

In the embodiment with a composite resonating composite body composed of plate 12 and beam 30, an exciting means must also be provided to start and maintain the resonant state. This excitation may be provided by a single coil exciting the plate 12, this excitation being then automatically transferred to the bar 30. Alternatively the composite body is excited by a coil 32 acting on bar 30. In yet another embodiment, two coils 20, 32 are used. In all these cases, excitation signals are received from the controller 22. Preferably, the main plate 12 and the beam 30 are driven at the same frequency but out of phase by 180 degrees so that the net vibration of apparatus becomes negligible. As a result, when the apparatus is used, the vibration or shaking of the plate 12 is eliminated by the vibration of beam 30 and the end result is that the apparatus holding probe assembly shown in the figure experiences only at most a negligible shake or vibration.

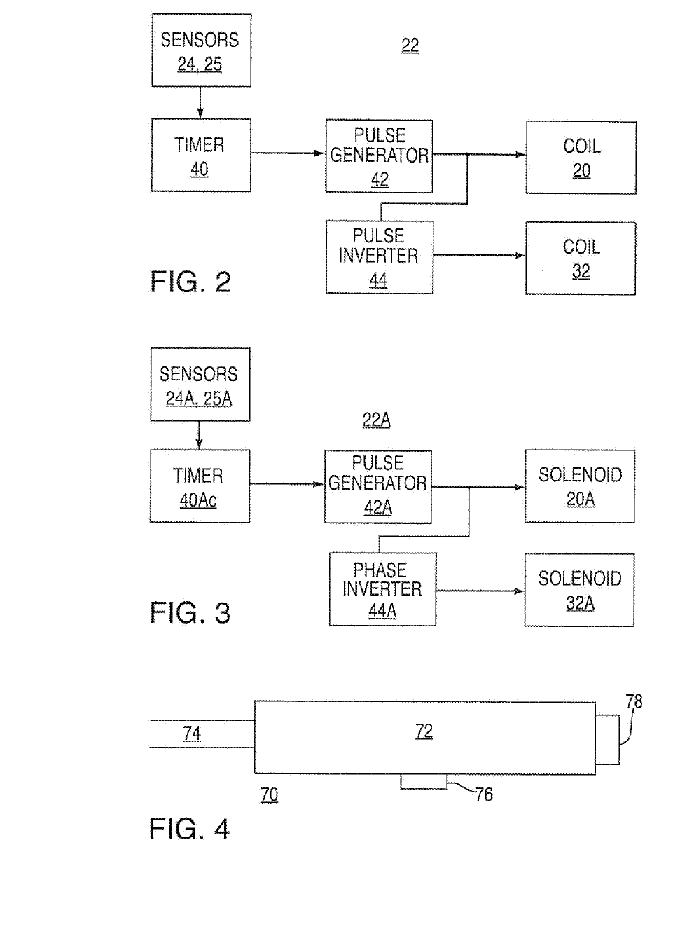

FIG. 2 shows a typical block diagram of controller 22 used for driving the coils. The controller includes a timer 40 receiving an input control signal that initiates the operation of the whole device. The timer 40 further receives an input from sensor 24 indicating the current position of the end 18 of beam 12. In response to these signals, the timer then generate timing signals indicative of when excitation of one or both beam 12 and arm 30 must be excited. These timing signals are fed to a pulse generator that generates the required excitation pulses S1 for coil 20. If necessary, in one embodiment, the pulse generator 42 also generates pulses S2 for coil 32. Alternatively, the controller 22 includes a phase inverter that receives the pulses S1 and generates corresponding pulses S2 that are delayed so that they are out of phase with pulses S1. Typically the phase delay is about 180 degrees. If necessary, the controller 22 also receives an input signal from a sensor 25 that monitors the position of the end 31 of beam 30 and uses the signals from both sensors 24 and 25 to determine the required timing signals for insuring that the resonant system is operating at the correct frequency.

In an alternate embodiment shown in FIG. 3, a mechanical excitation of the resonant system is provided. More particularly, the controller 22A includes a timer 40A receiving a control signal and an input from sensor 24. (If necessary, an input is also received from sensor 25 but has been omitted for the sake of clarity). The timer then generates timing signals to a pulse generator 42A. The pulse generator 42A then feeds excitation signals to a solenoid 44A that has a striker (not shown). When activated, the solenoid forces the striker to hit the plate 12 as required and cause it to vibrate at the natural resonant frequency of the mechanically resonating system formed by plate 12 and beam 30. If necessary, an inverter 46A is also provided that receives signals from the pulse generator 42A and provides in response the excitation signals for a second solenoid 48A for striking the bar 30.

Returning to FIG. 1, the apparatus or device 10 is used as follows. The apparatus positioned so that the probe 16 is disposed near and points to a patient's eye or some other similar target Y. The apparatus is activated causing the probe to vibrate along an arc of circle a covering an angle typically in the range of about ±5 degrees with respect to a central axis of the device. The probe sends out an ultrasonic beam toward the target. The resulting echoes are used together with the position of the probe as indicated by sensor 24 to generate images of the eye tissue in a conventional manner.

In the drawing the plate 12 and beam 30 have a specific shape and configuration, However it should be understood that these elements can have other shapes as well.

Typically, an ultrasonic device 70 includes, as shown in FIG. 4, an elongated body 72 sized and shaped so that it can be held in the palm if a person's hand. The body 72 is connected to a wire 74 that provides power to the electronic circuitry described above. The body includes a switch 76 used to activated the device. The body 72 includes a window 78 positioned toward the front through which ultrasonic sound waves are emitted and the resulting echoing signals are sensed.

Numerous modifications may be made to the invention without departing from the scope of the invention as defined in the appended claims.

We claim:

1. An ultrasonic device comprising:
a body sized and shaped to fit in a person's hand:
an ultrasonic probe arranged and constructed to selectively generate ultrasonic signals and to receive corresponding received signals from a target;
a plate having a first end and a second end, said first end being secured to said body to prevent its movement and a second end supporting said ultrasonic probe, said plate being made of a resilient material selected to provide said plate with a natural resonant mode in which said second end vibrates in a plane along an arc with respect to said first end; and
an excitation member coupled to said plate to cause said plate to enter into said resonant mode.

2. The device of claim 1 wherein said body is provided with a resonant system including said plate and a bar, said bar having a first bar end and a second bar end resonating in said plane with respect to said first bar end, said bar and said plate resonating in said resonant mode in opposite directions.

3. The device of claim 1 wherein said excitation member includes a portion attached to said plate and being responsive to magnetic fields, a control circuit and a coil selectively excited by said controller and cooperating with said portion to selectively initiate said natural resonant mode.

4. The device of claim 1 wherein said excitation member generates mechanical excitation to initiate said natural resonant mode.

5. An ultrasonic device for scanning a target comprising:
a body;
a resonant assembly disposed in said body, said resonant assembly and having a natural resonant mode, and including a first end secured to said body and a second end that vibrates at a predetermined frequency with respect to said first end;
a probe attached to said second end and selectively generating ultrasonic scanning signals for scanning the target; and
an excitation member disposed in said member for initializing said natural resonant mode.

6. The apparatus of claim 5 wherein said resonant assembly includes a plate having said first end and said second end and a bar attached to said plate and counterbalancing said plate in said natural resonant mode.

7. The apparatus of claim 6 wherein said plate is formed with a cutout and said bar is secured to said plate and is disposed in said cutout.

8. The apparatus of claim 7 further comprising a sensor sensing a current position of said second end, said sensor being coupled to said excitation member.

9. A method of scanning a target comprising:
providing a resonant assembly having a natural resonant mode determined of mechanical characteristics of said resonant assembly, said resonant assembly supporting a probe that is moved along a predetermined arc in said natural resonant mode;
positioning said resonant assembly with said probe generating ultrasonic pulses at the target; and
exciting said resonant assembly to cause said assembly to move said probe along a predetermined arc to scan said target.

10. The method of claim 9 further comprising sensing the position of said probe and adjusting said resonant mode in response to said sensing.

11. The method of claim 9 wherein said assembly is excited electrically to enter into said resonant mode.

12. The method of claim 9 wherein said assembly is excited mechanically to enter into said resonant mode.
